(19) United States
(12) Patent Application Publication
(10) Pub. No.: US 2006/0109847 A1
(43) Pub. Date: May 25, 2006

(54) Subscriber line accommodation apparatus and packet filtering method

(76) Inventor: Sou Satou, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/231,828

(22) Filed: Sep. 22, 2005

(30) Foreign Application Priority Data
Sep. 27, 2004 (JP) 280487 / 2004

(51) Int. Cl. H04L 12/56; H04J 1/02

(52) U.S. Cl. 370/389; 370/493; 370/401

(57) ABSTRACT

In a subscriber line accommodation apparatus, subscriber line termination units individually terminate a plurality of subscriber lines. An address information acquisition unit acquires address information of each communication terminal connected to the subscriber line terminated by the subscriber line termination unit. When the IP address of a communication terminal is designated, and one of an ARP request to acquire a MAC address corresponding to the IP address and an ARP response is done, an address information coincidence determination unit determines whether an address indicating the transmission source of an ARP packet used for the ARP request and the ARP response coincides with one of pieces of address information acquired by the address information acquisition unit. A packet sending control unit permits sending of the ARP packet when it is determined that the addresses coincide. A packet filtering method is also disclosed.

### BACKGROUND OF THE INVENTION

The present invention relates to a subscriber line accommodation apparatus and packet filtering method and, more particularly, to a subscriber line accommodation apparatus and packet filtering method which are suitable for regulating input of an ARP packet.

Opportunities are rapidly growing wherein a user terminal is connected to a communication network such as the Internet through a transmission line such as a telephone line or an optical cable. Along with this, DHCP (Dynamic Host Configuration Protocol) services are widely used in IP (Internet Protocol) networks, in which an IP address having a reusable form is dynamically assigned.

In a communication network using the DHCP service, an IP address is dynamically assigned to a user terminal. For this reason, no static filter can be set for the IP address. Hence, a third party can interfere with communication of another person or impose as another person by assuming a false IP address or MAC address.

A solution to this problem has been proposed by, e.g., reference 1 (Japanese Patent Laid-Open No. 2002-204246), in which MAC addresses (Media Access Control addresses) of all user terminals connected to subscriber lines accommodated in a subscriber line accommodation apparatus are registered. When a communication terminal different from these MAC addresses is going to access the network, the access is rejected (first proposal).

There is also proposed a subscriber line accommodation apparatus described in, e.g., reference 2 (Cisco-Cable Source-Verify and IP Address Security (http://www.cisco.com/warp/public/109/source_verify.html)). in which when a third party illicitly requests access to a communication network by using an IP packet, the access can be rejected (second proposal).

In the second proposal, when an IP packet arrives at a DHCP server to request acquisition of an IP address, an IP address is issued in response to the request. In addition, a set of the issued IP address, the identification number of the subscriber line for which IP address acquisition is requested, and the MAC address of the communication terminal which has issued the request is registered in a filter condition registration means. When a packet has arrived, packet communication is permitted for only a packet which coincides with the set of the IP address, identification number, and MAC address registered in the filter condition registration means. Communication is not permitted for a packet in which address information such as an IP address coincides but the subscriber line identification number does not coincide. Hence, illicit access can effectively be prevented.

The first proposal only executes static filtering by using a MAC address. The filtering target cannot be applied to a dynamic address.

In the second proposal, even a dynamic address is regulated. In the second proposal, however, only an IP packet is regulated. For this reason, when an ARP (Address Resolution Protocol) packet is sent to the subscriber line accommodation apparatus, effective filtering cannot be executed.

A supplementary explanation of the AARP packet will be given here. In communication on the Ethernet (registered trademark), even when an IP address is used in the communication of upper level, communication using a MAC address is executed eventually. ARP is used to acquire a MAC address. In ARP, a party “A” who wants to know a MAC address sets, in an ARP request packet, a known IP address corresponding to the MAC address and broadcasts the ARP packet to all nodes on the same network. A party “B” assigned the MAC address sets the MAC address in an ARP response packet and returns it to “A”. “A” can know the target MAC address by receiving the ARP response packet.

Because of the presence of the ARP packet, a third party who transmits an ARP response with a false IP address in response to an ARP request of another person can impose as that person and steal information of that person. Because of the presence of the ARP packet, a third party who transmits an ARP response with a false MAC address in response to an ARP request of another person can interfere with communication of that person. Because of the presence of the ARP packet, a third party who assumes a false IP address or MAC address of an ARP request can impose as another person and steal information of that person or interfere with communication of that person.

### SUMMARY OF THE INVENTION

It is an object of the present invention to provide a subscriber line accommodation apparatus and packet filtering method capable of ensuring the security of communication by preventing illicit access of a third party who assumes a false IP address or MAC address by using an ARP packet.

In order to achieve the above object, according to the present invention, there is provided a subscriber line accommodation apparatus comprising subscriber line termination units which individually terminate a plurality of subscriber lines, an address information acquisition unit which acquires address information of each of communication terminals connected to the subscriber lines terminated by the subscriber line termination units, an address information coincidence determination unit which, when an IP address of a communication terminal is designated, and one of an ARP request to acquire a MAC address corresponding to the IP address and an ARP response is done, determines whether an address indicating a transmission source of an ARP packet used for the ARP request and the ARP response coincides with one of pieces of address information acquired by the address information acquisition unit, and a packet sending control unit which permits sending of the ARP packet when it is determined by the address information coincidence determination unit that the addresses coincide.

There is also provided a packet filtering method comprising the steps of causing one of subscriber line termination units which individually terminate a plurality of subscriber lines to receive a packet, determining whether the received packet is an ARP packet, determining whether an address indicating a transmission source of the packet determined as the ARP packet coincides with address information of a communication terminal connected to one of the subscriber lines, and permitting sending of the ARP packet when it is determined that the addresses coincide.

### BRIEF DESCRIPTION OF THE DRAWINGS

FIG. 1 is a view showing the outline of the configuration of a multicast information distribution system to see TV pictures;

FIG. 2 is a block diagram showing the outline of a subscriber line accommodation apparatus and peripheral circuit configurations;

FIG. 3 is a block diagram showing the system configuration of main parts of the subscriber line accommodation apparatus;

FIG. 4 is a block diagram showing the outline of the hardware configuration of an integrated gateway unit;

FIG. 5 is a block diagram showing the main functional blocks of the integrated gateway unit;

FIG. 6 is a flowchart showing dynamic input management table update processing by a DHCP processing unit;

FIG. 7 is a flowchart showing the first half of packet reception control by dynamic input filter units;

FIG. 8 is a flowchart showing the second half of packet reception control by dynamic input filter units; and

FIG. 9 is a conceptual diagram of main parts of the subscriber line accommodation apparatus.

### DESCRIPTION OF THE PREFERRED EMBODIMENT

An embodiment of the present invention will be described below in detail with reference to the accompanying drawings.

<Outline of System>

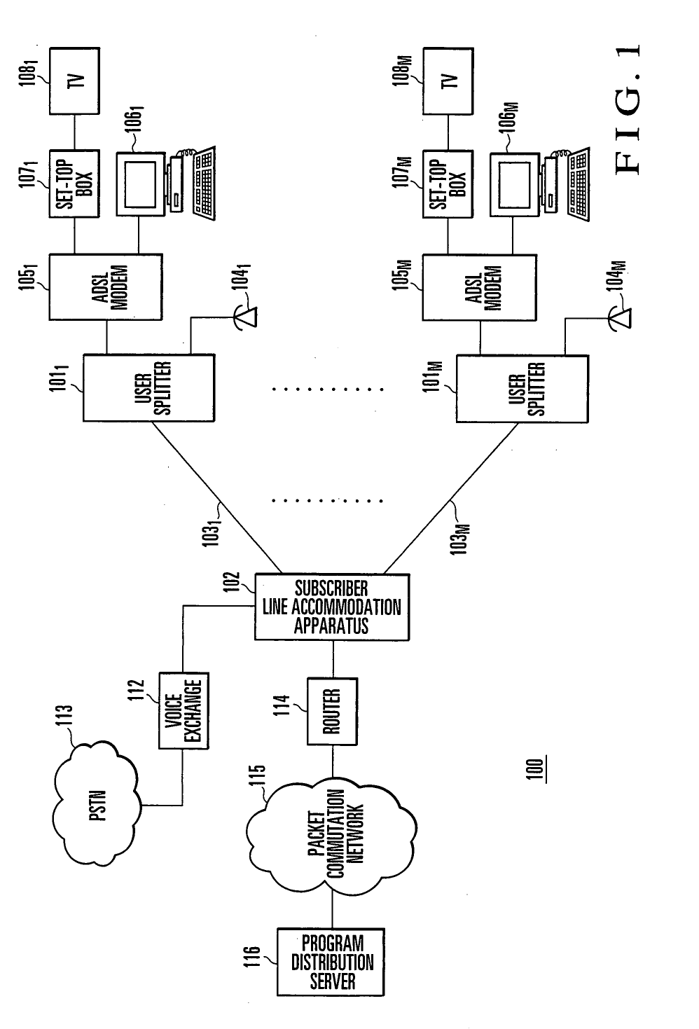

FIG. 1 shows the outline of a multicast information distribution system using a subscriber line accommodation apparatus of this embodiment. A multicast information distribution system 100 uses an asymmetric digital subscriber line called ADSL. The multicast information distribution system 100 connects user splitters 101₁ to 101_{M} arranged in subscriber's homes to a subscriber line accommodation apparatus 102 by DSL subscriber lines 103₁ to 103_{M}. Each of the user splitters 101₁ to 101_{M} is connected to a corresponding one of telephone sets 104₁ to 104_{M} and a corresponding one of ADSL modems 105₁ to 105_{M}. Personal computers 106₁ to 106_{M} to execute various kinds of data processing such as homepage browsing are connected to the ADSL modems 105₁ to 105_{M}, respectively. In addition, Internet televisions (TVs) 108₁ to 108_{M} to see TV programs are connected to the ADSL modems 105₁ to 105_{M} through set-top boxes 107₁ to 107_{M}, respectively.

The subscriber line accommodation apparatus 102 is connected to a voice exchange 112 and thus connected to a PSTN (Public Switched Telephone Network) 113. The subscriber line accommodation apparatus 102 is also connected to a packet commutation network 115 such as the Internet to execute packet commutation through a router 114. A program distribution server 116 to distribute various kinds of TV programs to the Internet televisions 108 of the users is connected to the packet commutation network 115.

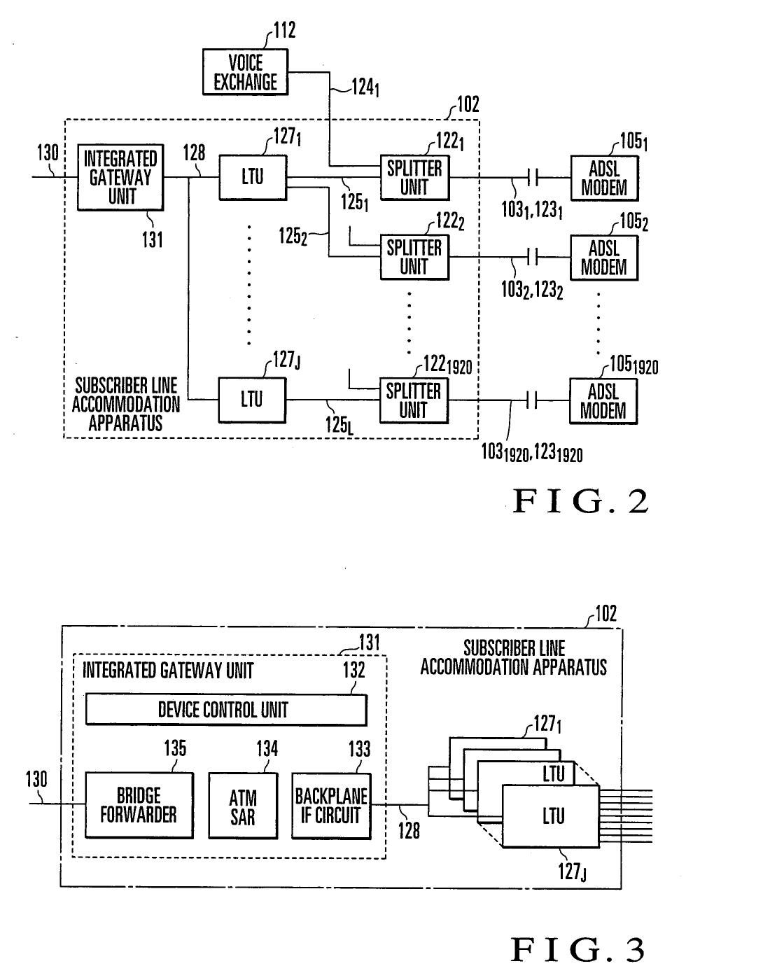

FIG. 2 shows the configuration of the subscriber line accommodation apparatus 102 and its periphery. The subscriber line accommodation apparatus 102 can accommodate 1,920 lines per system at maximum.

The subscriber line accommodation apparatus 102 comprises splitter units 122₁ to 122₁₉₂₀ connected to the ADSL modems 105₁ to 105₁₉₂₀ through the DSL subscriber lines 103₁ to 103₁₉₂₀, DSL subscriber line termination units (LTUs) 127₁ to 127_{J} serving as subscriber line termination units to individually terminate the DSL subscriber lines 103₁ to 103₁₉₂₀, and an integrated gateway unit 131. The splitter unit 122₁ and DSL subscriber line termination unit 127₁ will be described below representatively.

The splitter unit 122₁ splits a signal 123₁ sent through the DSL subscriber line 103₁ into a telephone signal 124₁ in the voice frequency band and an ADSL signal 125₁ in a predetermined frequency band higher than the voice frequency band. The telephone signal 124₁ is sent to the voice exchange 112 for line switching. The ADSL signal 125₁ split by the splitter unit 122₁ is modulated/demodulated by the initial stage (not shown) of the corresponding DSL subscriber line termination unit 127₁ to extract an ATM cell. The ATM cell is input to the integrated gateway unit (IGU) 131 through a backplane bus 128. The integrated gateway unit 131 will be described later in detail.

The DSL subscriber line termination unit 127₁ comprises a DSL transceiver module (DSP (Digital Signal Processor)) corresponding to a predetermined number of lines, for example, 32 lines at maximum. The DSL subscriber line termination unit 127₁ executes high-speed data communication in the up-link direction (the direction of the packet commutation network 115 in FIG. 1) through an up-link line 130 serving as an interface to connect to the Internet by using the DSL subscriber lines 103₁ to 103₁₉₂₀. The DSL subscriber line termination unit 127₁ also receives and modulates down link data and sends it to the DSL subscriber lines 103₁ to 103₁₉₂₀.

FIG. 3 shows the system configuration of main parts of the subscriber line accommodation apparatus 102. The subscriber line accommodation apparatus 102 comprises the DSL subscriber line termination units (LTUs) 127₁ to 127_{J} described in FIG. 2. The DSL subscriber line termination units 127₁ to 127_{J} are connected to one terminal of the integrated gateway unit 131. The integrated gateway unit 131 has an interface function to connect to the Internet. The up-link line 130 is connected to the other terminal of the integrated gateway unit 131.

The integrated gateway unit 131 comprises a device control unit 132 which controls and monitors the entire subscriber line accommodation apparatus 102, a backplane IF (interface) circuit 133 serving as the interface of the backplane, an ATM SAR (Asynchronous Transfer Mode Segmentation And Reassembly) 134 which assembles or segments an ATM (Asynchronous Transfer Mode) cell, and a bridge forwarder 135 which forward layer 2 and sorts packets on the basis of a MAC address (Media Access Control address). An ATM cell is transmitted between the ATM SAR 134 and the DSL subscriber line termination units 127₁ to 127_{J}. An Ethernet (registered trademark) frame is transmitted at the input/output portion of the up-link line 130.

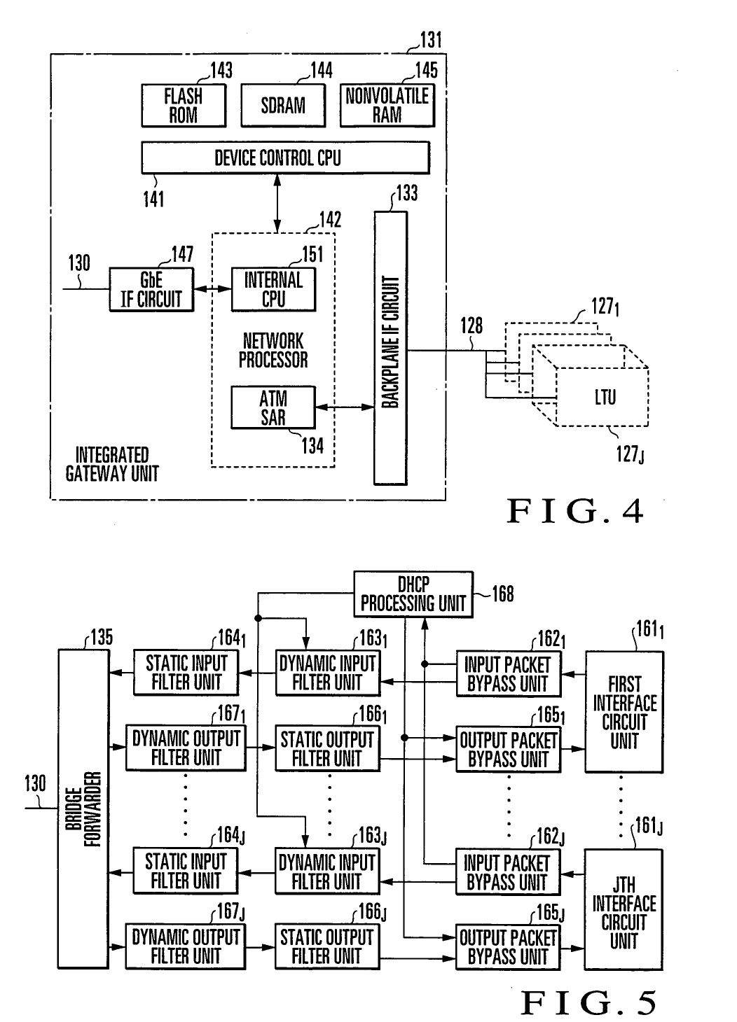

FIG. 4 shows the outline of the circuit configuration of the hardware of the integrated gateway unit 131. The integrated gateway unit 131 comprises two processors, i.e., a device control CPU (Central Processing Unit) 141 and a network processor 142, a memory group including a flash ROM (Read Only Memory) 143, an SDRAM (Synchronous Dynamic Random Access Memory) 144, and a nonvolatile RAM (Random Access Memory) 145, the backplane IF circuit 133 including an ASIC (Application Specific Integrated Circuit) serving as an integrated circuit for a specific application purpose, and a GbE (Gigabit Ethernet (registered trademark)) IF (interface) circuit 147 including an LSI (Large Scale Integration) (not shown).

The device control CPU 141 executes control related to device management, communication, or configuration setting. The network processor 142 is a high-speed communication processor having an internal CPU 151 and the ATM SAR 134. The bridge forwarder 135 shown in FIG. 3 is implemented as software by using the network processor 142 so that processes such as frame reception, destination determination, and transmission to the destination are executed by the bridge forwarder 135. The backplane IF circuit 133 implements, as hardware, various kinds of control related to the lines such as bus control to the lines to execute high-speed processing of a frame sent for each gigabit. The backplane IF circuit 133 processes the DSL subscriber line termination units 127₁ to 127_{J} individually by polling.

FIG. 5 shows the main functional blocks of the integrated gateway unit 131. The integrated gateway unit 131 comprises first to Jth interface circuit units 161₁ to 161_{J} arranged in correspondence with the DSL subscriber line termination units 127₁ to 127_{J} shown in FIG. 2. Between the bridge forwarder 135 and the first to Jth interface circuit units 161₁ to 161_{J}, series circuits including input packet bypass units 162₁ to 162_{J}, dynamic input filter units 163₁ to 163_{J}, and static input filter units 164₁ to 164_{J}, and series circuits including output packet bypass units 165₁ to 165_{J}, static output filter units 166₁ to 166_{J}, and dynamic output filter units 167₁ to 167_{J} are connected. A DHCP processing unit 168 is connected to the input packet bypass units 162₁ to 162_{J} and output packet bypass units 165₁ to 165_{J}. The first to Jth interface circuit units 161₁ to 161_{J} in FIG. 5 collectively represent the circuit portion on a side of the bridge forwarder 135 close to the DSL subscriber line termination units 127₁ to 127_{J} in FIG. 3.

The input packet bypass units 162₁ to 162_{J} sort received packets into packets to be sent to the DHCP processing unit 168 and those to be sent to the dynamic input filter units 163₁ to 163_{J}. The dynamic input filter units 163₁ to 163_{J} filter the received packets by using dynamic address information which changes over time. To the contrary, the static input filter units 164₁ to 164_{J} further filter the received packets by using static address information which does not change over time. The static output filter units 166₁ to 166_{J} statically filter packets to be sent in the direction of user terminal by using static address information. The dynamic output filter units 167₁ to 167_{J} dynamically filter the packets to be sent. Each of the output packet bypass units 165₁ to 165_{J} gives the packets sent from the static output filter units 166₁ to 166_{J} or the packets output from the DHCP processing unit 168 to a corresponding one of the first to Jth interface circuit units 161₁ to 161_{J} so that the packets are sent to a corresponding user terminal.

<Filtering Processing>

Table 1 shows part of a dynamic input management table incorporated in the dynamic input filter units 163₁ to 163_{J}. A dynamic input management table 171 lists IP addresses, MAC addresses, and subscriber line numbers assigned to the respective user terminals.

TABLE 1
Dynamic Input Management Table 171

| IP Address | MAC Address | Subscriber Line Number |
|---|---|---|
| 192.1.1.2 | 00:00:4C:35:27:A6 | 1/3 |
| 192.1.1.10 | 00:00:4C:8B:39:C2 | 1/24 |
| 192.1.1.18 | 00:00:4C:D3:9A:72 | 7/10 |
| . | . | . |
| . | . | . |
| . | . | . |
| . | . | . |
| . | . | . |
| . | . | . |

The user (DHCP client) of each subscriber terminal can be assigned an IP address ensured on the DHCP server side in advance by requesting an IP address of the DHCP server. At this time, the side of the DHCP processing unit 168 shown in FIG. 5 can acquire the assigned IP address and the MAC address and subscriber line number related to the user terminal. Hence, the DHCP processing unit 168 functions as an address information acquisition unit which acquires an IP address, MAC address, and subscriber line number assigned to a user terminal as address information.

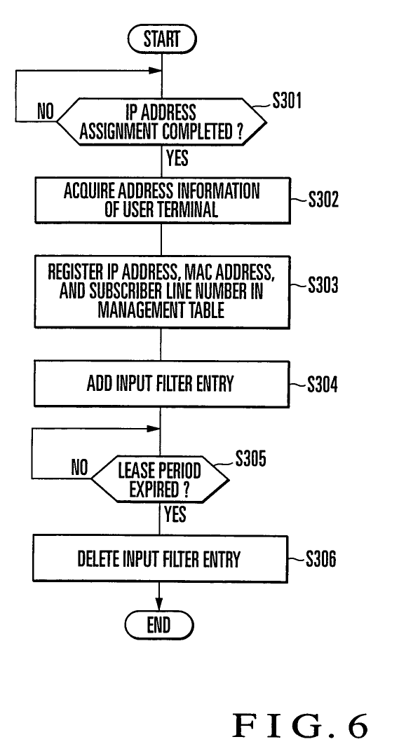

FIG. 6 shows update processing of the dynamic input management table 171 by the DHCP processing unit 168. When assignment based on an IP address assignment request to the DHCP server is completed (YES in step S301), the DHCP processing unit 168 acquires the address information of the user terminal (step S302). The IP address, MAC address, and subscriber line number as the acquired address information are registered in the dynamic input management table 171 shown in Table 1 (step S303). An input filter entry to filter the contents is added (step S304).

The DHCP server sets a lease period for an IP address assigned to each user terminal. Hence, the period until the lease period is expired is successively checked for each IP address (step S305). If the lease period is expired (YES), the input filter entry is deleted (step S306). This aims at permitting packet input only during the lease period.

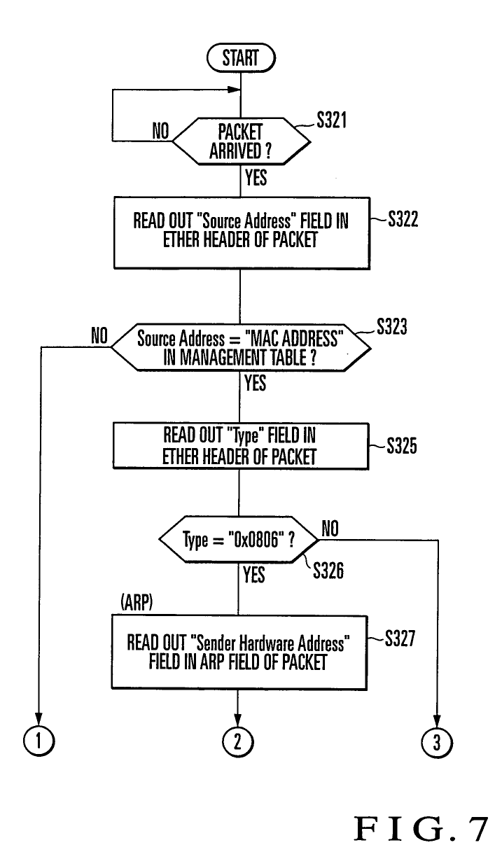

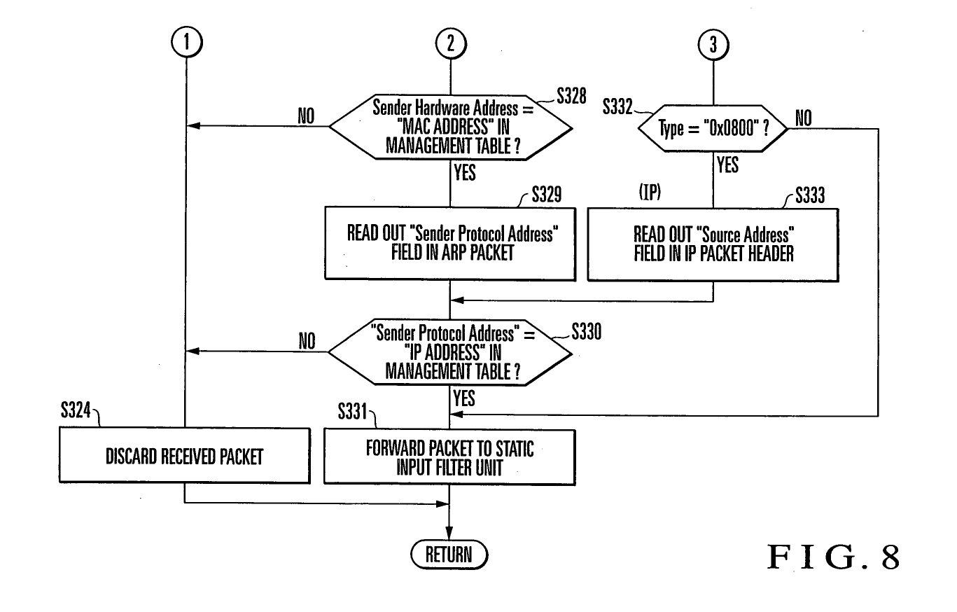

FIGS. 7 and 8 show packet reception control by the dynamic input filter units 163₁ to 163_{J}. This processing is executed by causing the device control CPU 141 in the integrated gateway unit 131 shown in FIG. 4 to execute a predetermined control program. The same control logic as in FIGS. 7 and 8 can also be implemented by hardware.

The device control CPU 141 monitors arrival of a packet from a corresponding user terminal side (step S321 in FIG. 7). When such a packet is sent from one of the DSL subscriber lines 103₁ to 103_{M} shown in FIG. 1 (YES), information in the “Source Address” field in the Ether (Ethernet (registered trademark)) header of the received packet (step S322). It is checked whether the source address coincides with one of the “MAC addresses” in the dynamic input management table 171 (step S323). If the addresses do not coincide, the transmission source user terminal of the received packet is not present. Hence, the received packet is discarded by a corresponding one of the dynamic input filter units 163₁ to 163_{J} (step S324 in FIG. 8).

If the information in the “Source Address” field of the received packet coincides with one of the “MAC addresses” (YES in step S323 in FIG. 7), information in the “Type” field of the packet is read out (step S325). If the information is “0×0806”, it is determined that the packet to be sent is an ARP packet (YES in step S326). “ARP” is a protocol to designate the IP address of a communication terminal and acquire a MAC address corresponding to the IP address and includes an ARP request and a response (ARP response) to the ARP request. A packet used for an ARP request or ARP response is called an “ARP packet”.

When the packet to be sent is determined as an ARP packet (YES in step S326), the “Sender Hardware Address” field in the ARP field of the packet is read out (step S327). It is checked whether the address coincides with a “MAC address” registered in the dynamic input management table 171 shown in Table 1 (step S328 in FIG. 8). If the addresses do not coincide (NO), no transmission source user terminal is present. Hence, the received packet is discarded by a corresponding one of the dynamic input filter units 163₁ to 163_{J} (step S324).

If the same address is present in the dynamic input management table 171 in step S328 (YES), the “Sender Protocol Address” field of the packet is read out (step S329). It is checked whether the address coincides with an “IP address” registered in the dynamic input management table 171 (step S330). If the addresses coincide (YES), the packet is sent to a corresponding one of the static input filter units 164₁ to 164_{J} and subjected to static filtering as before (step S331). If the addresses do not coincide (NO in step S330), the packet is discarded by a corresponding one of the dynamic input filter units 163₁ to 163_{J} (step S324).

If the “Type” field in the Ether header is not “0×0806” in step S326 in FIG. 7, i.e., the packet to be sent is no ARP packet (NO), it is checked whether the “Type” field is “0×0800” (step S332 in FIG. 8). If the “Type” field is “0×0800”, the packet is an IP packet. In this case (YES), “Source Address” in the IP packet header of the packet to be transmitted is read out (step S333). It is checked whether the source address coincides with the “IP address” registered in the dynamic input management table 171 (step S330). If the addresses coincide, the flow advances to step S331 to send the packet to a corresponding one of the static input filter units 164₁ to 164_{J}. If the addresses do not coincide, the packet is discarded (step S324).

If the “Type” field is not “0×0800” in step S332 (NO), the packet is sent to a corresponding one of the static input filter units 164₁ to 164_{J}. In this case, the received packet is neither an ARP packet nor an IP packet. In this embodiment, processing of this packet is not executed by the dynamic input filter units 163₁ to 163_{J} but by the static input filter units 164₁ to 164_{J} (step S331). The static input filter units 164₁ to 164_{J}, e.g., discard such a packet.

The packet sent to the static input filter units 164₁ to 164_{J} undergoes necessary filtering. The packet is input to the bridge forwarder 135 and sent to the up-link line 130 or output to the dynamic output filter units 167₁ to 167_{J}.

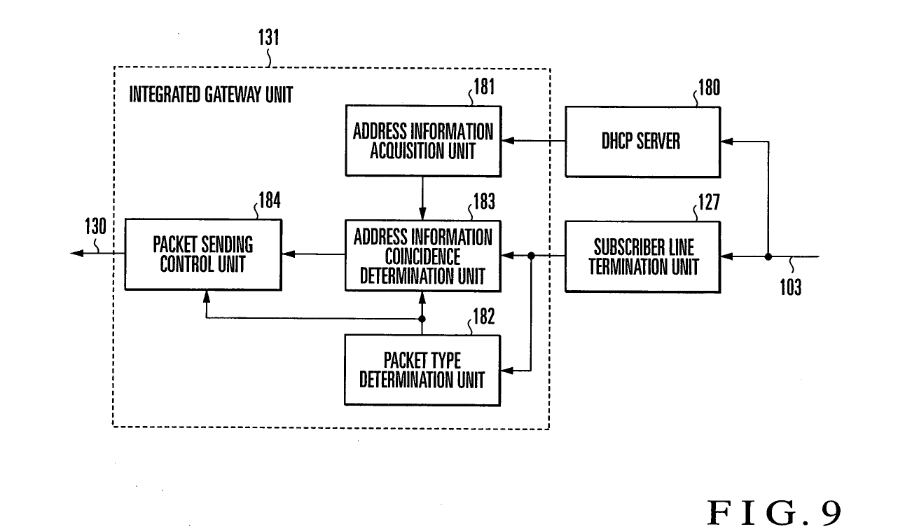

FIG. 9 shows main parts of the integrated gateway unit 131. Referring to FIG. 9, a subscriber line termination unit 127 is a circuit unit which individually terminates each of a plurality of subscriber lines 103. A DHCP server 180 is a server which assigns an IP address to a user terminal connected to the subscriber line termination unit 127 through the subscriber line 103.

The integrated gateway unit 131 comprises an address information acquisition unit 181, packet type determination unit 182, address information coincidence determination unit 183, and packet sending control unit 184.

The address information acquisition unit 181 acquires, from the DHCP server 180 as address information, a set of an IP address assigned to a user terminal, and a MAC address and subscriber line number related to the user terminal. More specifically, the address information acquisition unit 181 executes the operation in steps S301 to S306 in FIG. 6.

The packet type determination unit 182 determines whether a packet received by the subscriber line termination unit 127 is an ARP packet or IP packet. More specifically, the packet type determination unit 182 executes the operation in steps S325 and S326 in FIG. 7 and in step S332 in FIG. 8.

The address information coincidence determination unit 183 and packet sending control unit 184 apply address information acquired by the address information acquisition unit 181 in accordance with another logic depending on whether the determination result of the packet type determination unit 182 indicates an ARP packet or IP packet and control passage and discard of the received packet.

More specifically, when the received packet is determined as an ARP packet, the address information coincidence determination unit 183 determines whether the address (transmission source hardware address or transmission source protocol address) indicating the transmission source of the ARP packet coincides with one of pieces of address information (MAC address or IP address) acquired by the address information acquisition unit 181. If it is determined that the addresses coincide, the packet sending control unit 184 permits sending of the ARP packet. More specifically, the operation in steps S327 to S331 and S324 in FIGS. 7 and 8 is executed.

When the received packet is determined as an IP packet, the address information coincidence determination unit 183 determines whether the address indicating the transmission source of the IP packet coincides with one of pieces of address information (IP addresses) acquired by the address information acquisition unit 181. If it is determined that the addresses coincide, the packet sending control unit 184 permits sending of the ARP packet. More specifically, the operation in steps S333, S330, S331, and S324 in FIG. 8 is executed.

As described above, whether the received packet is an ARP packet or IP packet is determined, and address information coincidence processing is executed by another logic in accordance with the determination result. Hence, filtering corresponding to the characteristic of each packet is possible.

When the received packet is determined as an ARP packet, the address of the transmission source of the ARP packet is checked. If the address coincides with none of the pieces of address information of user terminals connected to the subscriber line termination units 127 through the subscriber lines 103, the ARP packet is discarded. With this arrangement, the safety level of communication for an ARP packet which especially poses a problem of security can be increased.

In the above-described embodiment, the DHCP processing unit 168 exists in the subscriber line accommodation apparatus 102, and the dynamic input management table 171 is created on the basis of address information such as an IP address acquired by the DHCP processing unit 168. However, the present invention is not limited to this. For example, the DHCP processing unit 168 or DHCP server 180 may independently exist outside the subscriber line accommodation apparatus 102. Instead, a DHCP relay agent which entrusts the DHCP processing unit 168 or DHCP server 180 with processing and acquires necessary information by communicating with them may be arranged in the subscriber line accommodation apparatus 102. In this case, the DHCP relay agent functions as the address information acquisition unit. The dynamic input management table 171 is created on the basis of address information acquired through the DHCP relay agent.

Even when no DHCP relay agent is present in the subscriber line accommodation apparatus 102, a packet itself which transmits address information flows in the subscriber line accommodation apparatus 102 comprising the subscriber line termination units 127 to individually terminate the plurality of subscriber lines 103₁ to 103_{M} if DHCP processing is executed. When a spoofing unit to spoof the address information is arranged in the subscriber line accommodation apparatus 102, the dynamic input management table 171 can be created in the same way as described above. In this case, the spoofing unit function as the address information acquisition unit.

The DHCP server 180 may exist in the subscriber line accommodation apparatus 102.

In the above-described embodiment, a DSL line has been exemplified as the subscriber line 103. However, the present invention is not limited to this, and any other subscriber line connected to the subscriber line termination unit 127 can be used. For example, the present invention can also be applied to a line using an optical fiber cable.

In the embodiment, an IP address or MAC address is checked as a filter condition. Regardless of the name, a dynamic address or absolute address may be used to impart the function of an input filter.

In the embodiment, filtering of a received packet is done by collation with the contents registered in the dynamic input management table 171. The present invention can also be applied even when the same filtering is executed without providing any specific table.

As described above, in the present invention, processing specialized to an ARP packet is executed as filtering in receiving a packet. Hence, the security of communication can be ensured by preventing illicit access of a third party who assumes a false IP address or MAC address by using an ARP packet.

What is claimed is:

1. A subscriber line accommodation apparatus comprising:
subscriber line termination units which individually terminate a plurality of subscriber lines;
an address information acquisition unit which acquires address information of each of communication terminals connected to the subscriber lines terminated by said subscriber line termination units;
an address information coincidence determination unit which, when an IP address of a communication terminal is designated, and one of an ARP request to acquire a MAC address corresponding to the IP address and an ARP response is done, determines whether an address indicating a transmission source of an ARP packet used for the ARP request and the ARP response coincides with one of pieces of address information acquired by said address information acquisition unit; and
a packet sending control unit which permits sending of the ARP packet when it is determined by said address information coincidence determination unit that the addresses coincide.

2. An apparatus according to claim 1, further comprising a packet type determination unit which determines whether a packet received by said subscriber line termination unit is one of an ARP packet and an IP packet,
wherein said address information coincidence determination unit and said packet sending control unit apply the address information acquired by said address information acquisition unit in accordance with another logic depending on whether a determination result of said packet type determination unit indicates the ARP packet or the IP packet and control passage and discard of the received packet.

3. An apparatus according to claim 1, wherein
said address information acquisition unit acquires a MAC address as the address information of the communication terminal, and
said address information coincidence determination unit determines whether a MAC address serving as the address indicating the transmission source of the ARP packet coincides with one of the MAC addresses acquired by said address information acquisition unit.

4. An apparatus according to claim 1, wherein
said address information acquisition unit acquires a MAC address as the address information of the communication terminal, and
said address information coincidence determination unit determines whether a transmission source hardware address serving as the address indicating the transmission source of the ARP packet coincides with one of the MAC addresses acquired by said address information acquisition unit.

5. An apparatus according to claim 1, wherein
said address information acquisition unit acquires an IP address as the address information of the communication terminal, and
said address information coincidence determination unit determines whether a transmission source protocol address serving as the address indicating the transmission source of the ARP packet coincides with one of the IP addresses acquired by said address information acquisition unit.

6. An apparatus according to claim 1, wherein
said address information acquisition unit acquires a MAC address and an IP address as the address information of the communication terminal, and
said address information coincidence determination unit determines whether a MAC address and a transmission source hardware address serving as the address indicating the transmission source of the ARP packet coincide with one of the MAC addresses acquired by said address information acquisition unit, and a transmission source protocol address serving as the address indicating the transmission source of the ARP packet coincides with one of the IP addresses acquired by said address information acquisition unit.

7. An apparatus according to claim 1, wherein the subscriber line is a DSL line.

8. An apparatus according to claim 1, wherein the subscriber line is a line using an optical fiber cable.

9. An apparatus according to claim 1, further comprising a DHCP server which assigns an IP address to the communication terminal.

10. An apparatus according to claim 9, wherein said address information acquisition unit acquires the assigned IP address from said DHCP server.

11. An apparatus according to claim 1, wherein said address information acquisition unit comprises a DHCP relay agent which is provided outside the apparatus and entrusts said DHCP server to assign the IP address to the communication terminal with processing.

12. An apparatus according to claim 1, wherein said address information acquisition unit comprises a spoofing unit which spoofs the IP address assigned to the communication terminal by said DHCP server provided outside the apparatus.

13. A packet filtering method comprising the steps of:
causing one of subscriber line termination units which individually terminate a plurality of subscriber lines to receive a packet;
determining whether the received packet is an ARP packet;
determining whether an address indicating a transmission source of the packet determined as the ARP packet coincides with address information of a communication terminal connected to one of the subscriber lines; and
permitting sending of the ARP packet when it is determined that the addresses coincide.

14. A method according to claim 13, further comprising the step of acquiring the address information of the communication terminal connected to each subscriber line.
